(19) United States
(12) Patent Application Publication
(10) Pub. No.: US 2026/0056766 A1
(43) Pub. Date: Feb. 26, 2026

(54) Distributed Agentic System

(71) Applicant: MediaTek Inc., Hsinchu City (TW)

(72) Inventors: Xiaofeng Li, San Jose, CA (US); Chun-Ming Su, Hsinchu City (TW)

(21) Appl. No.: 19/302,544

(22) Filed: Aug. 18, 2025

Related U.S. Application Data
(60) Provisional application No. 63/685,349, filed on Aug. 21, 2024.

(51) Int. Cl. G06F 9/455

(52) U.S. Cl. CPC G06F 9/45558; G06F 2009/4557

(57) ABSTRACT

A distributed agentic system includes multiple nodes that are communicatively connected. Each node is one of an edge device and a virtual machine (VM) operating on the edge device. Interaction peripherals are coupled to a subset of the nodes to receive user requests and output responses. In the distributed agentic system, an agentic manager receives a user request via one of the interaction peripherals. Based on the user request, the agentic manager sends a prompt to an artificial intelligence (AI) model managed by a model service. The agentic manager receives an action plan from the AI model, and calls at least one app according to the action plan to generate a response to the user request. The agentic manager, the AI model, the model service, and the at least one app are located on two or more of the nodes.

### CROSS-REFERENCE TO RELATED APPLICATIONS

This application claims the benefit of U.S. Provisional Application No. 63/685,349 filed on Aug. 21, 2024, the entirety of which is incorporated by reference herein.

### TECHNICAL FIELD

Embodiments of the invention relate to an agentic system that supports artificial intelligence (AI) agents on edge devices.

### BACKGROUND OF THE INVENTION

Agentic artificial intelligence (AI) systems are autonomous and goal-directed, with the ability to make decisions based on predefined goals and learned experiences. AI agents can utilize a variety of AI models for communicating with humans and accomplishing tasks. By utilizing diverse AI models, an agentic AI system can perceive its environment, make informed decisions, interact naturally with humans, and perform complex tasks autonomously without step-by-step human inputs. Agentic AI systems have the capabilities to function effectively across various domains and applications.

The AI models utilized in an agentic AI system may include machine learning models, deep learning models, natural language processing models, to name a few. Many of these models require a large memory footprint and computing resources. Typically, LLMs may be stored in a cloud and remotely accessible to users via networks. Cloud-based agentic AI systems introduce latency that impairs real-time responsiveness, particularly for time-sensitive or interactive tasks. Moreover, the use of cloud-based systems may raise privacy and data security concerns due to the transmission and remote processing of sensitive user data. However, edge devices are limited by memory size and computing resources. Thus, it is a challenge to provide an agentic AI system on edge devices.

### SUMMARY OF THE INVENTION

According to one embodiment, a method of a distributed agentic system is provided. The distributed agentic system includes a plurality of nodes that are communicatively connected, each of the nodes being one of an edge device and a virtual machine (VM) operating on the edge device. An agentic manager receives a user request via one of a plurality of interaction peripherals in the distributed agentic system. The plurality of interaction peripherals are coupled to a subset of the nodes to receive user requests and output responses. Based on the user request, the agentic manager sends a prompt to an AI model managed by a model service. The agentic manager receives an action plan from the AI model, and calls at least one app according to the action plan to generate a response to the user request. The agentic manager, the AI model, the model service, and the at least one app are located on two or more of the nodes.

In another embodiment, a distributed agentic system includes a plurality of nodes that are communicatively connected, and each node is one of an edge device and a virtual machine operating on the edge device. The distributed agentic system further includes a plurality of interaction peripherals coupled to a subset of the nodes to receive user requests and output responses. A given one of the nodes includes a processor and memory. The processor is operative to perform operations of an agentic manager to receive a user request via one of the interaction peripherals, send a prompt based on the user request to an AI model managed by a model service, receive an action plan from the AI model, and call at least one app according to the action plan to generate a response to the user request. The agentic manager, the AI model, the model service, and the at least one app are located on two or more of the nodes.

In one embodiment, the agentic manager initiates multiple user sessions in response to multiple user requests, where the multiple user requests are received via respective interaction peripherals. The agentic manager prompts AI models to obtain action plans targeting at one or more apps. The agentic manager generates action requests to apps according to the action plans, and maintains a first-in-first-out (FIFO) queue for action requests that target a same app. In one embodiment, the agentic manager according to the action plan invokes at least one service provided by one of the nodes to generate the response to the user request. In one embodiment, the agentic manager according to the action plan invokes a Web service provided by a cloud service provider to generate the response to the user request. In one embodiment, the interaction peripherals support one or more of: a graphic user interface (GUI), a voice user interface (VUI), and a sensing interface.

In one embodiment, the nodes communicate with each other via respective proxies over peer-to-peer communication channels. In an alternative embodiment, the nodes communicate with each other via respective proxies using a centralized name server or through a gateway.

In one embodiment, the agentic manager checks a database service that stores node identifiers identifying authorized nodes among the nodes. The agentic manager is authorized to invoke apps on the authorized nodes, and invokes the at least one app according to the action plan to generate the response. The at least one app resides on an authorized node different from a given node on which the agentic manager resides. In one embodiment, the agentic manager performs app discovery on a specific node when the user request specifies a node identifier identifying the specific node.

In one embodiment, a session manager of the model service manages concurrent model sessions for clients to access the AI models. The clients include one or more agentic managers and apps. The session manager, when managing the concurrent model sessions, interleaves access to a same AI model by the clients. In one embodiment, the session manager maintains a session context and a request history recording pending requests for each of the concurrent model sessions, and maintains a global request queue for all of the concurrent model sessions. The global request queue includes multiple entries with each entry indicating a pending request from one of the clients for one of the AI models. In one embodiment, the model service and a database service are shared by multiple agentic managers and multiple apps. The agentic managers and the apps are located on different nodes than where the model service and the database service are located.

In one embodiment, the agentic manager initiates a user session in response to the user request. The user session is stoppable during inference operations of the AI model. More details about a stoppable user session will be provided with reference to FIG. 8. When the agentic manager receives a stop request during the inference operations of the AI model, it pauses the user session and performs a context switch for the AI model to process the stop request. The AI model is used to process both the user request and the stop request. In one embodiment, the stop request is issued by another agentic manager on a second node different from a given node on which the agentic manager is located. In an alternative embodiment, the stop request is issued by one of a user and a service agent. In one embodiment, subsequent to pausing the user session, one of remove, restart, modify, and resume operations is performed with respect to the inference operations.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating an agentic framework according to an embodiment. according to an embodiment.

FIG. 2 is a block diagram illustrating interactions among framework components according to one embodiment.

FIG. 3 illustrates a peer-to-peer communication configuration of a distributed agentic system according to one embodiment.

FIG. 4 illustrates alternative communication configurations of a distributed agentic system according to some embodiments.

FIG. 5 is a diagram illustrating session management according to one embodiment.

FIG. 6 is a diagram illustrating operations of a session manager managing a model service according to one embodiment.

FIG. 7 is a flow diagram illustrating a method of a distributed agentic system according to one embodiment.

FIG. 8 is a diagram illustrating session stage management and context switching according to one embodiment.

FIG. 9 is a block diagram illustrating collaboration among multiple agentic managers according to one embodiment.

FIG. 10 is a flow diagram illustrating a method 1000 of collaborating agentic managers according to one embodiment.

FIG. 11 is a block diagram illustrating an agentic system operative to perform prompt session summarization according to one embodiment.

FIG. 12 is a flow diagram illustrating a method for prompt session summarization according to one embodiment.

FIG. 13 is a flow diagram illustrating a method performed by an agentic manager on an edge device for runtime update of app information according to one embodiment.

FIG. 14 is a block diagram illustrating a device in an agentic system according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation. As used herein, the term “and/or” includes any and all combinations of one or more of the associated listed items.

In the following description, the term “agentic manager” refers to a software application that can make autonomous decisions based on available and inferred information, to drive other applications (“apps”) or services. The term “agentic app” (abbreviated as “app”) refers to a software application that can be commanded and/or orchestrated by an agentic manager and take actions to provide services accessible to users, other apps, software, and/or systems. Although the term “app” or “apps” is used throughout the disclosure, the method and system described herein are not limited to an on-device app. In some embodiments, the method and system described herein are applicable to a service such as a Web service provided by a cloud service provider, an on-device service (e.g., system service, embedded service), etc. The term “cloud” refers to a remote system of server computers, storage, and software, providing services to edge devices over a network, such as the Internet. The term “edge device” (abbreviated as “device”) refers to a device that sits at the boundary of a local network and a wide-area network (e.g., the Internet) and provides an entry point to the wide-area network. Non-limiting examples of edge devices include smartphones, wearable devices, laptops, personal computers, Internet-of-things (IOT) devices, navigation devices, infotainment devices, robotic devices, smart home appliances, smart light/switches, etc. The term “AI model” (abbreviated as “model”) as used herein includes and is not limited to: machine learning models, deep learning models, customized learning models, natural language processing models, large language models (LLM), multi-modal models, neural networks and variations thereof, etc. The term “cloud AI model” or “cloud model” refers to an AI model in the cloud, and “edge AI model” or “edge model” refers to an AI model installed on an edge device. The term “edge nodes” (abbreviated as “nodes”) herein encompasses virtual machines (VMs) and physical devices such as edge devices. A system may include multiple nodes, which may be VMs, edge devices, or a combination of both.

In one embodiment, an agentic framework (“framework”) may be deployed on a distributed agentic system that includes multiple nodes. Components of the framework (“framework components”) may be distributed across the multiple nodes. One of the framework components is an agentic manager on one of the nodes to coordinate the operations of the other framework components.

In one embodiment, a distributed agentic system may include multiple interaction peripherals in one device or in multiple network-connected devices. In one embodiment, different framework components may run on different VMs in one device or multiple devices. In one embodiment, a distributed agentic system may include multiple agentic managers sharing the same model service and/or the same database service. In one embodiment, the multiple agentic managers may be multiple agentic manager instances that are instantiated from the same agent manager definition. In one embodiment, an agentic manager may operate (i.e., call, invoke, etc.) apps and/or services that are located on multiple VMs and/or devices. In another embodiment, an agentic manager may invoke services in the cloud as well as apps and/or services that are located on multiple VMs and/or devices.

The agentic manager(s) and the apps working together are “agentic” in that they can make autonomous decisions to achieve a given goal, for example, a goal given by a user or by another app or by another device. The autonomous decisions may be based on learned data, metadata, pre-configured data, a combination of these data, etc. In one embodiment, the agentic manager(s) use AI models to perform AI operations. In one embodiment, one or more of the apps may also use AI models to perform AI operations.

Using a smart home as an example. A distributed agentic system may support multiple interaction peripherals, such as smart microphone and speaker, TV, wearable devices, smart phones, cameras, IoT devices, etc., from any of which a user can issue requests. In an embodiment where the distributed agentic system is distributed across multiple devices, an agentic manager and system functions may run on a router, model services and database services may run on a home server, and apps may run on a smart TV or IoT devices to control door locks, thermostats, lights, etc. In one embodiment, the distributed agentic system may support multiple agentic managers running on multiple devices such as one agentic manager on a smart TV, another agentic manager on a tablet, yet another agentic manager on a refrigerator. In one embodiment, multiple agentic managers may share the same model service and/or database service. The model service and/or database service may run on the same device or VM, and at least one of the multiple agentic managers runs on another device or VM. In a smart home, an agentic manager on a smartphone can operate apps on other devices; non-limiting examples include smart TVs, tablets, IoT devices, etc.

As another example, a distributed agentic system may support multiple interaction peripherals in a vehicle, such as multiple displays in a vehicle. For example, there may be one display for the driver, another display for the front passenger, and two displays for the backseats. In one embodiment, a smart cockpit device in a vehicle may run an agentic manager and apps on one VM, and run the model services and the database services on another VM. In one embodiment, an agentic manager on a smartphone can operate apps on the smart cockpit device. Alternatively or additionally, an agentic manager on a smart cockpit device can operate apps on a smartphone. In one embodiment, multiple agentic managers may run on multiple devices and VMs in a vehicle.

The agentic framework described herein is deployed on an agentic system. Thus, in the following description, the terms “agentic framework” and “agentic system” may be used interchangeably. A distributed agentic system is an agentic system that includes multiple nodes. Unless otherwise specified, the methods described below may be applied to both a distributed agentic system deployed on multiple edge nodes and an agentic system deployed on a device.

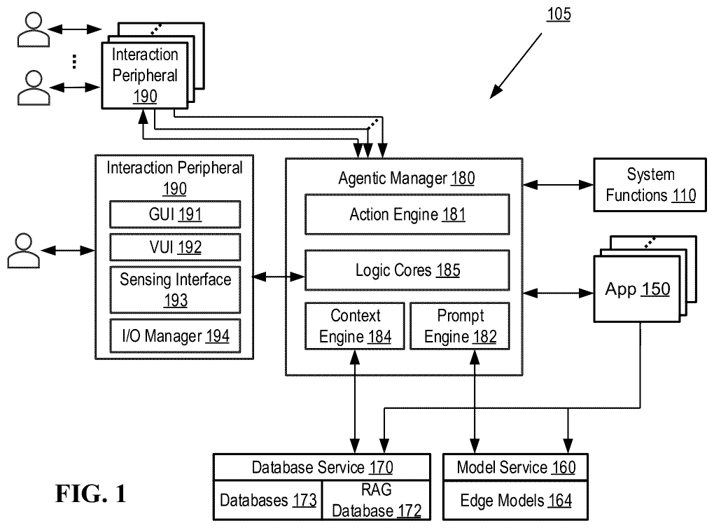

FIG. 1 is a block diagram illustrating an agentic framework 105 (“framework 105”) according to an embodiment. Non-limiting examples of the framework components in the framework 105 include an agentic manager 180, an agentic app (“app 150”), a model service 160, a database service 170, and one or more interaction peripherals 190. In one embodiment, the framework 105 may include multiple agentic manager 180, multiple apps 150, and/or multiple interaction peripherals 190. The agentic manager 180 is an agentic management application operative to manage the apps 150, and interact with the model service 160, the database service 170, the interaction peripherals 190, and users. The agentic manager 180 may also access apps and/or AI models in the cloud.

The model service 160 manages the AI models in the framework 105. These AI models are installed on one or more devices, and, therefore, are referred to as edge models 164. The edge models 164 may be accessed by the agentic manager 180 and some of the apps 150. The edge models 164 may include base models, low-rank adaptation (LoRa) models, ControlNet models, and other additional models. Each model is described by corresponding model metadata, which may be stored in databases 173 and/or a retrieval augmented generation (RAG) database 172 to facilitate fast searching. The databases 173 can be searched by keywords or other means. The RAG database 172 is also referred to as a vector embedding database or embedding database. The vector embeddings (also referred to as “embeddings”) are a numerical representation of the semantics of the stored data. An embedding database enables an efficient and accurate search for semantically similar information. Embeddings are usually, but not limited to, high-dimensional vectors encoding semantic contexts and relationships of information.

The database service 170 manages the databases 173 and the RAG database 172. In one embodiment, the model metadata may be stored in the RAG database 172 for vector embedding search (also referred to as “similarity search”) and similarity ranking. Similarity ranking refers to the ranking of the search results according to their similarity to a search criterion, e.g., search for a target model that meets the requirements of an app 150. The model service 160 may automatically set a target model of an app 150 according to the model requirements indicated in the app metadata. The app metadata describes the features of the app 150 and the requirements on the models that the app 150 uses. The app metadata may be converted by the database service 170 into vector embeddings and stored in the RAG database 172. In one embodiment, the app metadata describes what action requests that a given app can accept. The app metadata may further specify a specific model for the given app to use, or specify the requirements for a model to be used by the given app. In some embodiments, the app metadata may also describe one or more rules or hints that can be used by the agentic manager 180 to call the given app.

In one embodiment, the agentic manager 180 includes an action engine 181, a prompt engine 182, and a context engine 184, the operations of all of which are coordinated by logic cores 185. The agentic manager 180 interacts with the apps 150, the model service 160, and the database service 170. The agentic manager 180 also interacts with one or more users via the one or more interaction peripherals 190. The agentic manager 180 has access to the edge models 164. In some embodiments, the agentic manager 180 also has access to system functions 110, which provides system built-in functionalities in the device where the agentic manager 180 is located. Non-limiting system built-in functions include services such as time, location, device maker information, device ID information such as phone number, device settings such as font size, device control functions such as flight mode, etc. The system functions 110 are different from the apps 150 in that the system functions 110 are built-in functions of the system, while the apps 150 are independently developed capabilities.

In one embodiment, each interaction peripheral 190 is an I/O peripheral device that can interact with users and/or the environment. The interaction peripheral 190 provides various forms of I/O for a user to interact with the framework components. The operations of the interaction peripheral 190 may be managed by an I/O manager 194. For example, the interaction peripheral 190 may receive user inputs via touch, voice, text, and/or the like. Non-limiting examples of the interaction peripheral 190 may include cameras, sensors, displays, speakers, microphones, IoT devices, robots, etc. The interaction peripheral 190 also produces outputs to users and/or other I/O devices. In some embodiments, the interaction peripherals 190 may include IoT devices having service agents (e.g., software, firmware, and/or hardware components) installed thereon, where the service agents are controllable by the agentic manager 180. The interaction peripheral 190 may support one or more of: a graphic user interface (GUI) 191, a voice user interface (VUI) 192, a sensing interface 193, and/or other I/O interfaces. The GUI 191 may provide graphical icons or links on a display screen for a user to select, and generate graphical outputs for the user to view. The VUI 192 may provide speech-to-text functions (e.g., automatic speech recognition (ASR)) and text-to-speech (TTS) functions to convert user speech input into text, and text output to speech. The sensing interface 193 may include touch sensors to sense users' touch, cameras to detect users' gestures, etc.

The framework 105 provides edge-device users with an agentic experience in a user-intuitive way. The agentic manager 180 may utilize one or more edge models 164 for natural language processing, speech recognition, and speech generation. In one embodiment, the agentic manager 180 may be invoked by a trigger phrase from the user, e.g., “hi there”.

In one embodiment, the framework 105 is deployed on multiple nodes, which includes devices, VMs on one or more devices, or a combination of both. The devices in the framework 105 are connected by a network.

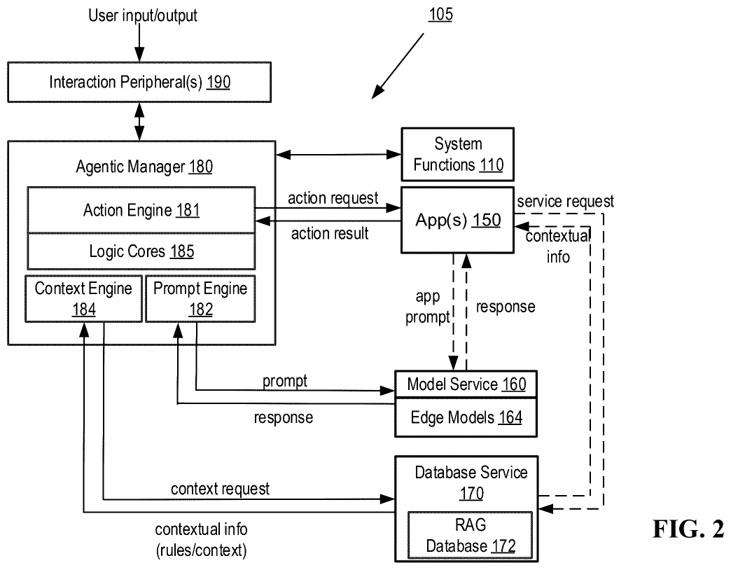

FIG. 2 is a block diagram illustrating interactions among framework components according to one embodiment. Upon receiving a user request, the interaction peripheral 190 forwards the user request to the agentic manager 180. The user request may specify a task. The agentic manager 180 (more specifically, the context engine 184) sends a context request to the database service 170 for contextual information of the user request, such as the identities of one or more apps providing the requested service. The database service 170 performs a similarity search in the RAG database 172 based on the similarity between the stored app metadata and the phrases in the user request. In one embodiment, the contextual information generated from the similarity search contains local information and/or user preference information that can be used by the agentic manager 180 to prompt one of the edge models 164, referred to as a target model. The contextual information can improve the quality and the precision of the response generated by the target model, and, thereby, enhance the user experience. In one embodiment, the contextual information may identify one or more of the apps 150 as target apps to provide the service requested by the user.

After receiving the contextual information, the agentic manager 180 (more specifically, the prompt engine 182) sends a prompt to the agentic target model, where the prompt incorporates the contextual information. For example, the prompt may include a request for planning actions. The target model generates a response including an action plan, indicating the action requests that the agentic manager 180 can send to a target app. The agentic manager 180 (more specifically, the action engine 181) sends an action request to the target app. The target app executes the action and returns an action result to the agentic manager 180. In one embodiment, the target app may use the database service 170 and/or the model service 160 to respond to the action request. In some scenarios, the agentic manager 180 may send additional action requests to one or more apps according to the action plan. The agentic manager 180 may send the action result to the user via the interaction peripheral 190 for user's further input or confirmation. When the task specified by the user request is completed, the agentic manager 180 sends an output to the user indicating the completion of the task. In one embodiment, operations of the agentic manager 180 are coordinated by the logic cores 185.

In one embodiment, the communication between the agentic manager 180 and the apps 150 is bi-directional. The agentic manager 180 requests the target app to take actions, and the target app sends action results to the agentic manager 180. For example, the action may be to order a burger, and the action result may be a list of burgers offered by food ordering apps. The list may be provided to the agentic manager 180 as an action result, and the agentic manager 180 may consult one or more AI models, online sources, and/or the on-device databases to supplement the list with relevant information (e.g., nutrition and/or price) before generating an output to the user. In some scenarios, the action result from the target app to the agentic manager 180 may be an indication of “success” or “failure” with respect to the food order. In carrying out the action request, the target app may use one or more AI models to generate the action result. In some scenarios, the target app may generate output without using AI models.

As mentioned before, the framework components may be distributed across multiple devices and/or multiple VMs. Before describing the management of the framework component in a distributed framework, it is helpful to first explain the terms “user request’ and “user session.” A user request is a request sent by a user to ask the agentic manager 180 to perform a task. A user session is a session that starts when a user sends a request to the agentic manager 180 for performing a task and ends when the task is completed. As a non-limiting example, upon receiving a user request, the agentic manager 180 is operative to process the user request, access a model, access a database, request a target app to take action, and output a response to the user. A user session may include one or more iterations of interactions between the user and the agentic manager 180. For example, the agentic manager 180 may ask the user for clarification, and the user may provide feedback to the agentic manager 180.

Referring to FIG. 1, in one embodiment, the multiple interaction peripherals 190 may reside on multiple respective devices. The I/O manager 194 and the I/O interfaces (e.g., GUI 191, VUI 192, sensing interface 193, etc.) supported by the interaction peripheral 190 on the same device may run on one or more VMs. In one embodiment, the agentic manager 180 may handle user requests received by multiple interaction peripherals 190 in one of the following operational modes: a first mode of sequential session execution and a second mode of concurrent session execution. In the sequential session execution mode, the agentic manager 180 processes user sessions one at a time, regardless of whether the session requests originate from the same or different interaction peripherals 190. Incoming session requests are stored in a first-in, first-out (FIFO) queue. The agentic manager 180 initiates the processing of the next session request only after the completion of the currently active session. In the concurrent session execution mode, the agentic manager 180 allows multiple user sessions to be processed concurrently. While user sessions may run in parallel, the agentic manager 180 maintains a FIFO queue for action requests that target the same app 150. This ensures that such action requests are executed sequentially in the order they were received, thereby preserving the logical consistency and integrity of interactions with each app 150.

Referring to FIG. 1, in one embodiment, multiple apps 150 may reside on multiple nodes. The apps 150 on the same device may run on one or more VMs. In one embodiment, the agentic manager 180 can operate the apps 150 on the local device (i.e., the same device as where the agentic manager 180 is located) and on remote devices (i.e., different devices from where the agentic manager 180 is located). The agentic manager 180 and the apps 150 may run on the same VM or different VMs. The agentic manager 180 and the apps 150 may run on the same operating system (OS) or different OSs.

As a non-limiting example, in a smart home environment, an agentic manager on a smartphone may control apps hosted on external devices such as smart TVs, tablets, and/or IoT devices. As another non-limiting example, in an automotive environment, an agentic manager on a smartphone may operate apps in a smart cockpit system, and vice versa.

The framework 105 supports the following coordination operations to enable the agentic manager 180 to operate the apps 150 hosted on remote nodes in a distributed system. The term “remote node” in the context of a distributed system refers to an edge node (e.g., device or VM) different from the node that the agentic manager 180 resides on. In one embodiment, the database service 170 maintains app metadata and node identifiers (e.g., device IDs or network addresses). The node identifiers identify the nodes having apps thereon that the agentic manager 180 is authorized to call. If a user request specifies a node identifier, the agentic manager 180 limits its application discovery to the specified node. If no node is specified, the agentic manager 180 may prompt the user to provide such information. Alternatively, the agentic manager 180 may proceed to search for applicable apps 150 across all known nodes. In cases where multiple candidate apps are found, the agentic manager 180 selects one of the apps 150 based on internal selection policies, user-defined preferences, or by requesting user confirmation.

Prior to initiating a search for remote apps, the agentic manager 180 verifies the operational availability of the target node. If the user specifies a node that is currently unavailable, the agentic manager 180 provides a response to the user to indicate the node's unavailability. If the user does not specify a node, only currently available nodes are included in the search scope.

When dispatching an action request to a target app hosted on a remote node, the agentic manager 180 transmits the action request to a local proxy along with the remote node's metadata. The local proxy then forwards the action request to a remote proxy located on the remote node, which in turn routes the action request to the target app.

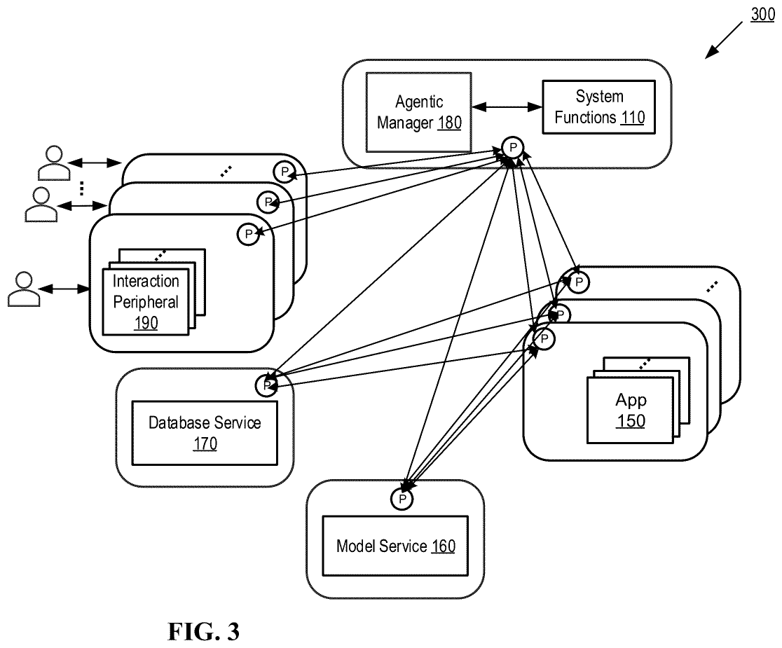

FIG. 3 illustrates a peer-to-peer communication configuration of a distributed agentic system 300 according to one embodiment. In this embodiment, the components of the framework 105 (FIG. 1) reside on multiple nodes (i.e., multiple devices and/or VMs). In FIG. 3, each block with rounded corners represents a node. The framework components include one or more interaction peripherals 190, the apps 150, the agentic manager 180, the model service 160, and the database service 170. These framework components communicate with one another via their respective available data communication channels. The selection and configuration of these channels depend on the relative locations and execution environments of the interacting framework components.

In one embodiment, when two framework components are deployed on two different devices, communication between the two framework components can be established via available wired or wireless data channels, including but not limited to TCP/IP over the Ethernet, Wi-Fi, Bluetooth, or similar protocols. In one embodiment, when two framework components are deployed on two different VMs on the same device, inter-VM communication can be facilitated using cross-VM data channels; e.g., by configuring the VMs to use the same network such as TCP/IP over a bridged network, network address translation (NAT), or equivalent mechanisms.

In one embodiment, a proxy (shown in FIG. 3 as “P” in a circle) is provided in each node where one or more framework components reside. The proxies are operative to pass inter-component communication data to one another. The proxy abstracts and encapsulates the underlying communication protocol details, thereby decoupling the component logic from low-level protocol handling and ensuring portability and modularity of the component implementations.

Multiple communication modes for inter-proxy communication are supported. In the peer-to-peer mode shown in FIG. 3, each proxy maintains an address table of all other peer proxies. Communication occurs directly between proxies without intermediary components.

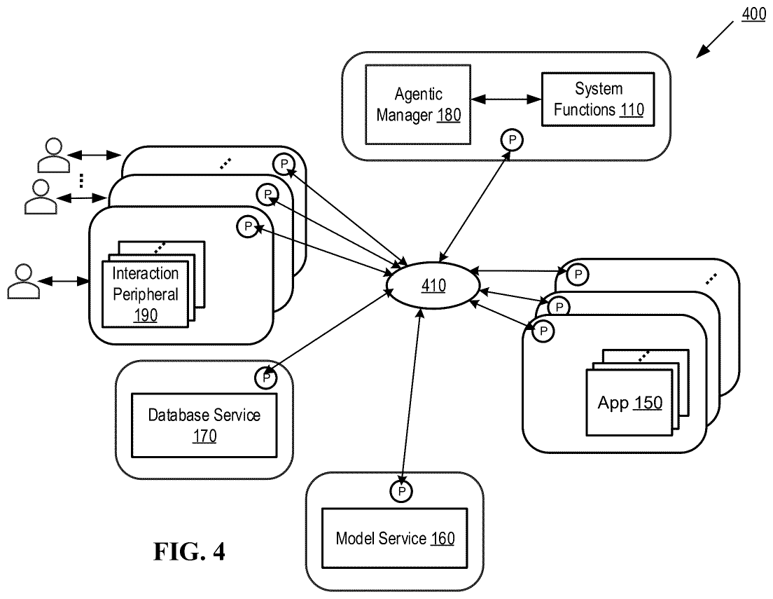

FIG. 4 illustrates alternative communication configurations of a distributed agentic system 400 according to some embodiments. In one embodiment, the element 410 represents a name server residing in a node, which can be one of the nodes that host one or more of the framework components, or another node. In the name server mode, a centralized name resolution service is provided by a name server. The proxies of the framework components query the name server to resolve the address of a destination proxy prior to initiating communication destination proxy. In another embodiment, the element 410 represents a gateway server. In the gateway mode, a centralized gateway server functions as an intermediary message dispatcher. Each proxy transmits data to the gateway server, which forwards the data to a destination proxy. In the gateway mode, the proxies do not need to maintain knowledge of other proxy addresses.

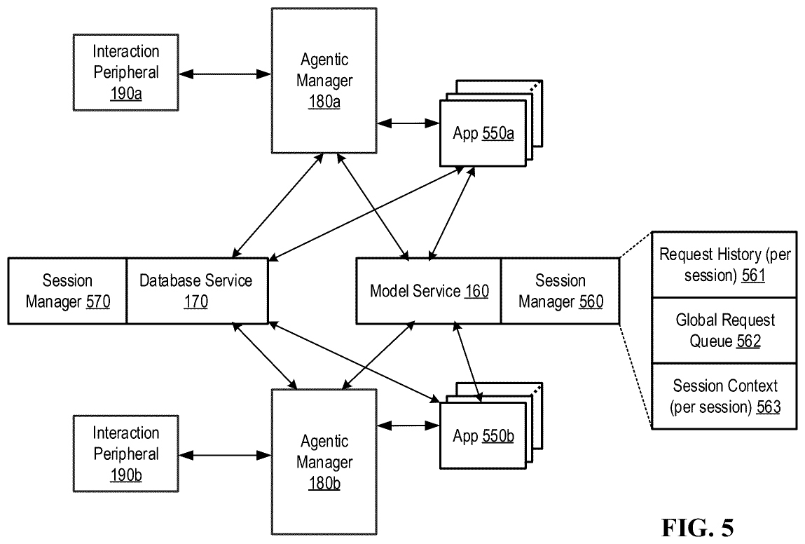

FIG. 5 is a diagram illustrating session management in a distributed agentic system according to one embodiment. In this embodiment, multiple agentic managers (e.g., 180a and 180b) run on multiple nodes and share the same model service 160 and/or database service 170. The model service 160 and/or database service 170 may run on the same node as one of the agentic managers (180a or 180b), or run on another node(s). The model service 160 and the database service 170 each use a respective session manager (560 and 570) to facilitate concurrent access by multiple clients, where clients include the agentic managers (180a and 180b) and apps (550a and 550b). These session managers 560 and 570 are responsible for managing the concurrent access while preserving session-specific state for each client.

As used herein, a model session starts when a client opens a session with the model service 160 to access a specified model, and ends when the client closes the session. Each connection to a model from a client creates a unique model session. A model session is specific to a pair of a model and a client. A database session starts when a client opens a session with the database service 170 to access a database, and ends when the client closes the session.

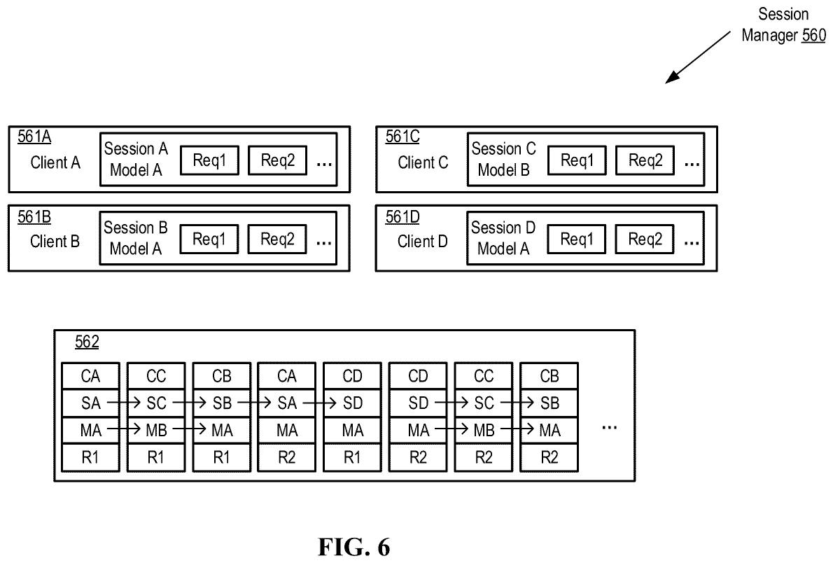

A mechanism for model session management is provided to allow multiple clients in a distributed agentic system to access model services while preserving system resource usage on an edge device. A multi-core device (e.g., a device with multiple neural processing units (NPUs)) can support parallel execution of concurrent sessions. However, requests within a model session are executed sequentially regardless of how many NPUs are available. When there are multiple concurrent model sessions requesting services from the same model, the session manager 560 maintains a session state and a session context for each model session. During a model session, the session manager 560 maintains both a request history 561 and a session context 563 for each session. The request history 561 records the pending requests that originate from a client waiting to be issued to a given model in a model session. Additionally, the session manager 560 maintains a global request queue 562 to keep track of all pending requests for model services for all clients in the concurrent model sessions. The order of the requests in the global request queue 562 can be first-in-first-out (FIFO), priority-based, or based on a predetermined policy. Each entry in the global request queue 562 indicates a pending request from one of the clients for one of the AI models. As will be shown with reference to FIG. 6, the session manager 560 interleaves the access to a model by multiple clients, enabling time-shared access to the same model.

The session manager 560 retrieves the requests from all clients' request histories 561 and enqueues them into the global request queue 562. Requests are then dequeued and dispatched to a corresponding model for execution. Upon completion of a request, or upon interruption of the given model's current execution, the session manager 560 dequeues the next request in the global request queue 562 for processing.

Before dispatching a client's request to a model, the session manager 560 performs two checks to determine if updates to the client's session context 563 are necessary. Once session context management (i.e., a first check and a second check) is complete, the new request is dispatched to the model.

In one embodiment, the session manager 560 performs the first check to determine whether the client associated with the to-be-dispatched request (the “new client”) is different from the client associated with the model's last executed request (the “last client”). If they are the same client, no update to the session context 563 is necessary. If the clients are different, the model's last execution state is saved to the session context 563 of the last client. This saved context replaces the previously stored context 563 for that client.

If the first check indicates that the new client is different from the last client, the session manager 560 performs the second check to determine whether the new client has a previously saved session context 563 for the model. If such a context exists, it is loaded and used to restore the model's execution state, allowing the session to resume as if the session of the new client were continuous.

FIG. 6 is a diagram illustrating operations of the session manager 560 according to one embodiment. In this non-limiting example, four clients' request histories are shown: 561A, 561B, 561C, and 561D. The requests (e.g., Req1, Req2, etc.) in each request history are made by a corresponding client and are not yet executed. The session manager 560 scheduled these requests for execution in the global request queue 562 according to a predetermined policy. In the example of the global request queue 562, Cx represents a client and Sx represents a session (where x=A, B, C, or D). MA represents Model A and MB represents Model B. R1 and R2 represent Req1 and Req2, respectively. The arrow between two sessions indicates a change of sessions, causing a context switch. The arrow between two models indicates a model change.

In one embodiment, the session manager 560 may preemptively interrupt model execution prior to request completion. In such cases, the execution state may not be saved to the session context 563 of the current client. Depending on the operational policies, the last saved session context 563 for that client may be cleared (e.g., invalidated or deleted).

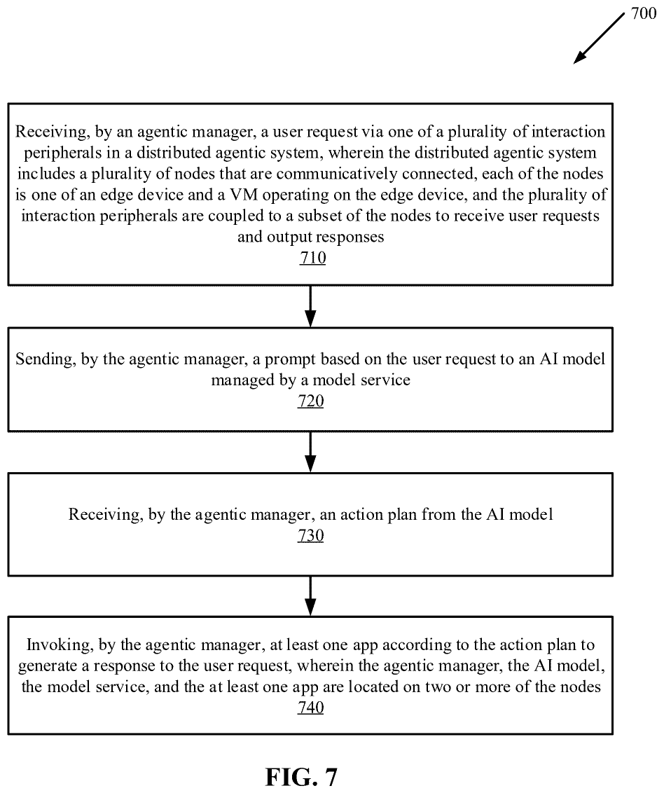

FIG. 7 is a flow diagram illustrating a method 700 of a distributed agentic system according to one embodiment. Non-limiting examples of the distributed agentic system operable to perform the method 700 may include any of the embodiments shown in FIG. 1-FIG. 5. The method 700 begins at step 710 when an agentic manager receives a user request via one of interaction peripherals in the distributed agentic system. The distributed agentic system includes multiple nodes that are communicatively connected. Each node is an edge device or a VM operating on an edge device. The interaction peripherals are coupled to a subset of the nodes to receive user requests and output response. At step 720, the agentic manager sends a prompt based on the user request to an AI model managed by a model service. At step 730, the agentic manager receives an action plan from the AI model. At step 740, the agentic manager invokes at least one app according to the action plan to generate a response to the user request. The agentic manager, the AI model, the model service, and the at least one app are located on two or more of the nodes.

The following description turns to the management of session interruption and termination with respect to user sessions. A user session is a session that starts when a user sends a request to an agentic manager for performing a task and ends when the task is completed. Under some conditions, a user session may be stopped before a requested task is completed. The stop request may be initiated by a user or framework components.

Referring to FIG. 1, a user session may be stopped by a user via a GUI, voice, etc., provided by the interaction peripheral 190. This may occur when the user no longer wishes to wait for the ongoing user session to complete. Alternatively or additionally, a user session may be stopped by the apps 150 (e.g., a high-privileged system service). An app 150 used in a user session may stop an ongoing user session, for example, in response to a detected error or failure condition. A system service may cancel a time-consuming action when a thermal condition is detected (e.g., when a thermal threshold is exceeded). In one embodiment, an app 150 not currently used in the ongoing user session, but has a higher priority than the task executed in ongoing user session, may issue a request to stop the ongoing session. Depending on the system architecture, such a request may be directed to the agentic manager 180, the model service 160, or both. In another embodiment where the framework 105 includes multiple agentic managers, a first agentic manager operating on a first node may issue a stop request to stop a user session being executed on a second node. The stop request is transmitted to a second agentic manager on the second node via an inter-system communication channel. In the following description, the embodiment of FIG. 1 is used as a non-limiting example for user session management. It is understood that each of the embodiments of FIG. 1-FIG. 5 can perform user session management. It is also understood that the user session management can be performed in a non-distributed agentic system. In some embodiments, a standalone device that performs the operations of an agentic system may perform user session management.

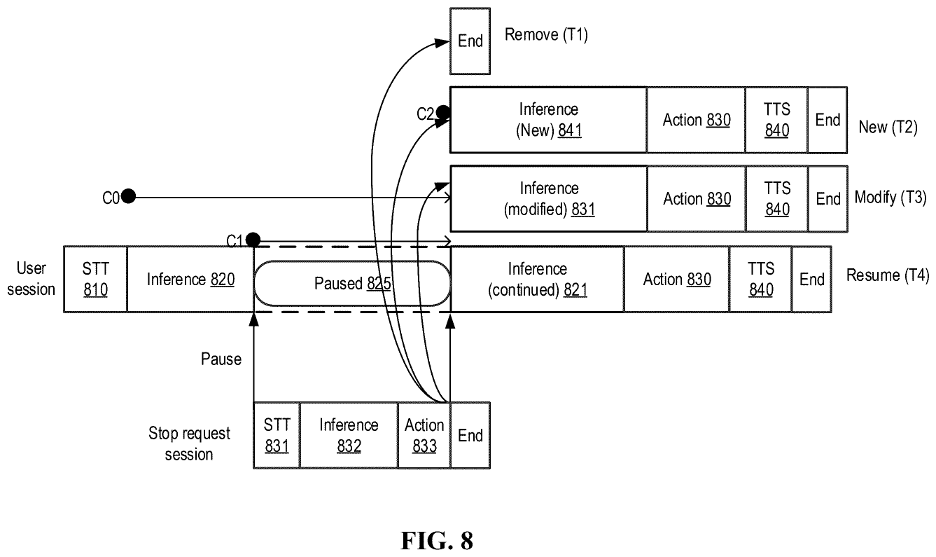

FIG. 8 is a diagram illustrating session stage management and context switching according to one embodiment. A user session may include multiple discrete processing stages, e.g., speech-to-text (STT) stage 810, model inference stage 820, action stage 830, and text-to-speech (TTS) stage 840.

In one embodiment, a stop request may be received during the model inference stage 820. The stop request session may include an STT stage 831, an inference stage 832, and an action stage 833. The stop request interrupts the inference stage 820, causing the inference to pause 825. A context switch is performed when the inference stage 832 of the stop request begins. This is the case when the agentic manager 180 utilizes the same model to process both the ongoing user session and the incoming stop request session. In such a scenario, the ongoing model inference is interrupted to allow processing of the stop request. Referring also to FIG. 8, upon processing the stop request, the node receiving the stop request may perform one of the following operations. (T1) Remove ongoing user session, where the ongoing user session is abandoned and transitioned to a finished state (i.e., end). (T2) Start a new session, where the ongoing user session is discarded and a new user session with a new inference stage 841 and a new session context (C2) is initialized and executed. (T3) Modify the user request. The session context (C0) saved at the beginning of the inference stage 820 of the ongoing user session is restores, and the user session continues with a modified inference stage 831 based on a modified user request. (T4) Resume the ongoing user session with a continued inference stage 821 and a session context (C1) restored from the point when the user session was interrupted.

In scenarios where a stop request is received during the other stages of the user session (e.g., the STT stage 810, the action stage 830, or the TTS stage 840), the agentic manager 180 may interrupt and terminate the processing of that stage.

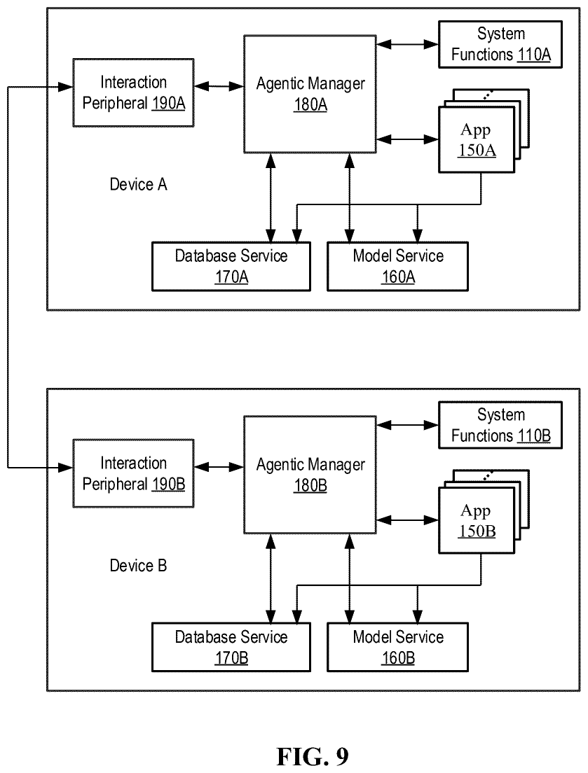

FIG. 9 is a block diagram illustrating collaboration among multiple agentic managers according to one embodiment. In one embodiment, multiple agentic managers 180 operate on respective devices may work collaboratively when requested by users. In one embodiment, these devices are independent devices and do not share agentic framework components. In one embodiment, these devices may incorporate coordination functionalities to enable their respective agentic managers to work collaboratively when requested by users. More specifically, the agentic managers of these devices may collaborate through their respective interaction peripherals to fulfill user requests. Two non-limiting examples are provided below.

In a first example, User A and User B operate Device A and Device B, respectively. Each device includes an agentic manager (180A, 180B), a set of apps (150A, 150B), an interaction peripheral (190A, 190B), system functions (110A, 110B), model service (160A, 160B), and database service (170A, 170B). When User A sends a request to Device A such as “Set up a meeting for both me and User B and mark the calendar”, the agentic manager 180A on Device A may generate a number of sub-requests using an AI model (e.g., one of the models managed by the model service 160A) to process the semantic structure of User A's request. For example, the agentic manager 180A may process the request by decomposing it into a sequence of two sub-requests. The first sub-request is directed to itself to create a calendar entry for User A, including User B as a participant. The second sub-request is sent to the agentic manager 180B on Device B to create a corresponding calendar entry for User B, including User A as a participant.

In a second example, User A may own both Device A and Device B running the agentic managers 180A and 180B, respectively. Device A has a basic photo album app, and Device B has a more powerful and resource-intensive photo enhancement app. When User A issues a request to Device A such as “Get the latest photo and use Device B to enhance it, then send it back to me,” the agentic manager 180A may process the request by decomposing it into a sequence of multiple sub-requests. The first sub-request is a local sub-request to retrieve the most recent photo on Device A or the cloud and transmit it to Device B. The second sub-request is a remote sub-request to the agentic manager 180B to apply the photo enhancement app on the photo and return the enhanced photo to Device A. The third sub-request is a local sub-request to display the returned enhanced photo on Device A.

It is understood that the above examples with reference to FIG. 9 also apply to a distributed agentic framework in which framework components in Device A and Device B are distributed over multiple nodes. The term “agentic system” refers to a system in which an agentic framework is deployed. In one embodiment, an agentic system may be a device. In another embodiment, an agentic system may be a distributed network of nodes.

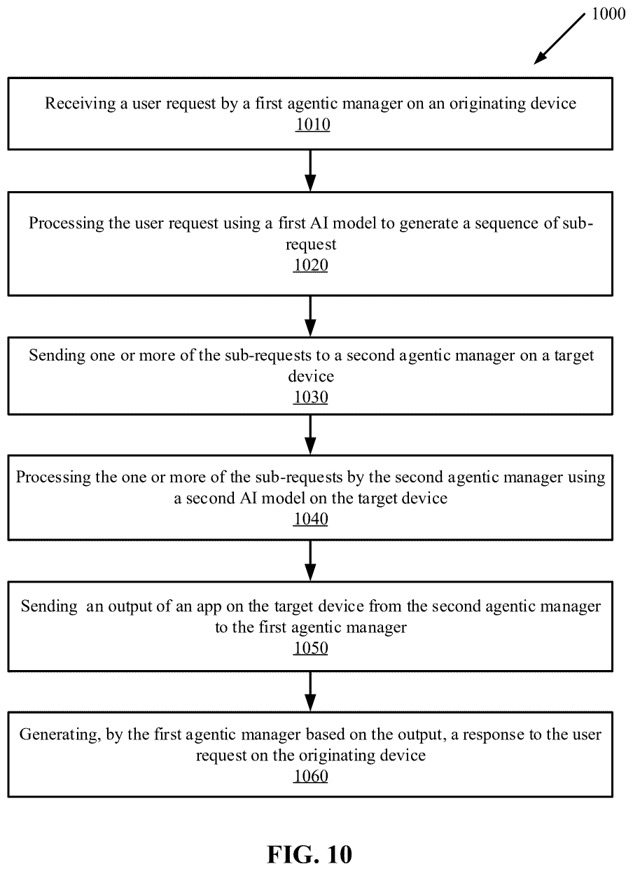

FIG. 10 is a flow diagram illustrating a method 1000 of collaborating agentic managers according to one embodiment. Although two agentic managers (e.g., a first agentic manager “Agent_A” and a second agentic manager “Agent_B”) are described in this example, it is understood that the method 1000 extends to multiple (e.g., more than two) collaborating agentic managers, e.g., when an originating device (of the user request) uses multiple target devices to satisfy the user request. Referring also to FIG. 9, Agent_A and Agent_B may be examples of the agentic managers 180a and 180b, respectively. Furthermore, while “devices” are used in the following example, it is understood that the method 1000 is applicable to scenarios in which Agent_A and Agent_B are framework components of respective agentic systems.

In one embodiment, the method 1000 starts with step 1010 when Agent_A on the originating device receives a user request. At step 1020, Agent_A processes the user request using an AI model to generate a sequence of sub-requests. The AI model may semantically parse the user request in generating the sequence of sub-requests. The AI model determines whether each sub-request is to be executed locally on the originating device or on the target device. The AI model may also analyze dependencies in the sub-requests and determine an execution sequence of the sub-requests accordingly. At step 1030, Agent_A sends one or more of the sub-requests to Agent_B on the target device. In a scenario where multiple target devices are used, Agent_A may send the sub-requests to these target devices according to the execution sequence. In one embodiment, each sub-request may be accompanied by a session identifier or metadata to ensure correct handling of the collaborative actions.

At step 1040, upon receiving a sub-request from the first agent, Agent_B processes the sub-request using a second AI model on the target device. Agent_B handles the sub-request similar to how it would handle a user request. Agent_B may use the second AI model to analyze the sub-request and plan actions. Agent_B may invoke the actions of available apps on the target device. At step 1050, Agent_B sends an output of an app on the target device to Agent_A. At step 1060, Agent_A based on the output generates a response to the user request on the originating device.

In one embodiment, Agent_A may determine the target device for collaboration based on user actions, e.g., bumping, tapping, or bringing two devices into proximity, which may be detected by sensors in the originating device as an indication of collaboration intent. For example, the two devices may detect each other's presence by Near-Field Communication (NFC) or short-range wireless communication using Bluetooth, Wi-Fi, etc. Once Agent_B agrees to set up a connection with Agent_A, a temporary peer-to-peer connection is established for Agent_A to send sub-requests to Agent_B. Alternatively or additionally, Agent_A may determine the target device for collaboration based on a device identifier or other device identification information in the user request.

In some embodiments, the target device may receive the sub-request by any available wired or wireless channels, e.g., Bluetooth, Wi-Fi, Ethernet, cellular network, etc. A sub-request may be sent from Agent_A by a notification such as text, messaging, email, push notifications, short message service (SMS), etc. Agent_B may receive and parse the notification to extract the sub-request content and process the sub-request. In one embodiment, the target device may provide a notification listener service that can be implemented in an email or message app. If the user of the target device grants the necessary permissions, Agent_B can receive notifications from Agent_A and extract the sub-requests using a protocol and/or an application programming interface (API) between the app and Agent_B. Agent_B may return a response, results, or an acknowledgment to Agent_A.

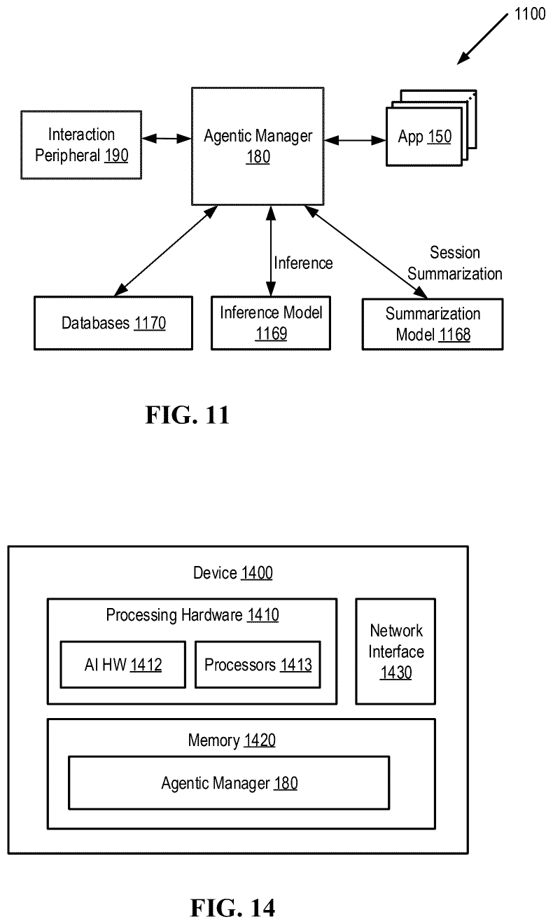

FIG. 11 is a block diagram illustrating an agentic system 1100 operative to perform prompt session summarization according to one embodiment. In the agentic system 1100, fulfilling a user request involves interactions between the agentic manager 180 and one or more AI models, databases 1170, apps 150, system functions 110, and the user. The interaction between the agentic manager 180 and an inference model 1169 (which is an edge AI model) is referred to as a prompt session, where the agentic manager 180 sends prompts—including data from the user, databases 1170, apps 150, the agentic manager 180 itself, and other models—to the inference model 1169. The inference model 1169, in turn, generate inference responses that are returned to the agentic manager 180. The agentic system 1100 is an edge-side system in that at least the agentic manager 180, the inference model 1169, and a summarization model 1168 reside on one or more edge devices.

A prompt session may include multiple rounds of prompt-response exchanges between the agentic manager 180 and the inference model 1169. When a new prompt is sent to the inference model 1169, the model generates its inference based on the combination of the new prompt and all of the accumulated prior prompts within the prompt session. That is, the actual input for the current inference includes the entire accumulated prompts within the prompt session.

However, AI models typically impose a token size limit for inference. The total token size includes both input (i.e., prompt) and output of an AI model in a prompt session. The token size limit caps the size of the accumulated prompts in a prompt session. As more prompts are accumulated, the fewer tokens can be used for model output. In some embodiments, AI models may impose a prompt size limit, which limits the total length of model inputs in a prompt session. Thus, older prompts in a prompt session are discarded when the accumulated prompt size in the prompt session exceeds the prompt size limit, or when the total token size in the prompt session exceeds the token size limit. Because earlier prompts may contain critical information necessary for accurate inference, truncating them can lead to degraded or inaccurate results—an undesirable outcome in agentic systems.

In one embodiment, the agent manager 180 may provide automated prompt session summarization and history memorization techniques to manage the accumulated prompt size in a prompt session. In one embodiment, the agentic manager 180 automatically summarizes portions or all of the prompts in the entire prompt session, producing a summary to preserve essential information while reducing length. For example, the essential information may include keywords, key sentences, key facts, etc., in each prompt. The summary may be a shorter version of the prompts where long sentences are re-worded into an equivalent, shorter version. This summary can then replace the original prompts in subsequent model inferences, thereby maintaining prompt history without exceeding the token size limit.

In one embodiment, before sending a new prompt to the inference model 1169 in a prompt session, the agentic manager 180 first sends the new prompt to the summarization model 1168, which is also an edge AI model. The summarization model 1168 generates a summary of the new prompt and sends the summary back to the agentic manager 180. The agentic manager 180 then uses the summary to prompt the inference model 1169 to continue the prompt session. The summarization of a new prompt is especially helpful when the new prompt contains a large amount of data such as a lengthy article.

Alternatively or additionally, before sending a new prompt to the inference model 1169, the agentic manager 180 may use the summarization model 1168 to summarize the accumulated past prompts in the prompt session, and restart a new prompt session with the summary. That is, the agentic manager 180 starts a new prompt session of the inference model 1169 using the summary of the accumulated past prompts as an initial prompt.

In one embodiment, the summarization model 1168 may be a large language model (LLM), which summarizes content by analyzing the input text, identifying key information, and then rephrasing it in a shorter, more concise form. This process can involve either extracting key sentences directly from the text or generating new sentences that capture the main ideas.

In one embodiment, upon completing a prompt session, the agentic manager 180 summarizes all of the session's prompts using either the inference model 1169, the summarization model 1168, or another AI model, and stores the resulting prompt session summary in the databases 1170 for future reference.

The summarization process serves not only to manage prompt size constraints but also to persist or memorize key session information (such as user preferences, past actions, or app operation steps) in a database. This stored prompt session summary can be used in future sessions to improve system performance, personalization, and/or efficiency.

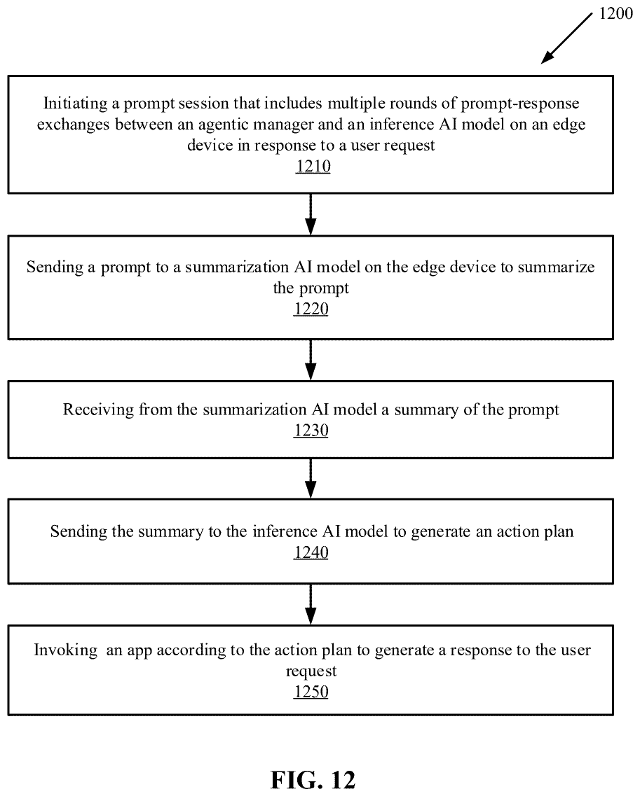

FIG. 12 is a flow diagram illustrating a method 1200 for prompt session summarization according to one embodiment. The method 1200 begins with an agentic manager at step 1210 initiating a prompt session in response to a user request, where the prompt session includes multiple rounds of prompt-response exchanges between the agentic manager and an inference AI model on an edge device. At step 1220, the agentic manager sends a prompt to a summarization AI model on the edge device to summarize the prompt. The agentic manager at step 1230 receives from the summarization AI model a summary of the prompt. The agentic manager at step 1240 sends the summary to the inference AI model to generate an action plan. At step 1250, the agentic manager invokes an app according to the action plan to generate a response to the user request.

In all of the aforementioned embodiments of agentic framework and agentic systems, when an agentic manager orchestrates the actions of apps, services, and/or devices, (including services, devices, and similar components), it typically requires access to detailed app information (i.e., app metadata) including features, application programming interfaces (APIs), and internal data. This app information can be utilized by the agentic manager, with the assistance of one or more AI models, to plan and trigger app actions. The app information may also be incorporated into prompts sent to the AI models or stored in one or more databases (including RAG database) for the agentic manager to query.

Because the operation of the agentic manager depends on this app information, it is typically stored in the database prior to the agentic manager initiating any actions on the app—for example, during installation of the app on an edge device or at the time of initial framework deployment. This process is referred to as deploy-time database setup.

However, deploy-time database setup suffers from a key limitation: app information can change over time. As a result, by the time the agentic manager orchestrates actions on the apps, the stored app information may be outdated. For example, the database may contain the menu data of a restaurant app (e.g., a KFC app) from the time of deployment, but the restaurant's menu may have changed by the time the agentic manager interacts with the app, leading to inaccurate or incorrect system behavior.

In one embodiment, the agentic manager retrieves app information at runtime and stores it in the database for runtime query. An app is called a foreground app when the app is started and becomes ready for action. Foreground apps also include those apps that were running in the background and are brought to the foreground ready for action. When an app becomes a foreground app or when the agentic manager itself is started, the agentic manager issues a query to the foreground apps to retrieve the latest app information. When the agentic manager receives the new app information, it updates the database with the new app information.

To manage database updates efficiently, the system maintains a database-update-time for each app either at the app or the agentic manager. The database-update-time of an app indicates the most recent time the app information was updated in the database. In one embodiment, apps in the system maintain respective info-change-time. The info-change-time of an app indicates the most recent point at which its app information was modified. In a scenario where an app does not track its info-change-time, the current query time (with respect to the query sent by the agentic manager) may be used as its info-change-time.

In a first embodiment, database-update-time is maintained by each app. When the app receives a query from the agentic manager, the app compares its info-change-time with the stored database-update-time. If the info-change-time is more recent than the database-update-time, the app returns the new app information to the agentic manager and updates the database-update-time with the info-change-time. The agentic manager then updates the database with the new app information. If the info-change-time is not more recent than the database-update-time, the app informs the agentic manager that the app information is unchanged since the last database update and no update is needed.

In a second embodiment, database-update-time is maintained by the agentic manager. When an app responds to the agentic manager's query, it returns both its app information and its info-change-time. The agentic manager then compares the received info-change-time with the stored database-update-time of the app. If the info-change-time is more recent than the database-update-time, the agentic manager updates the database with the new app information and also updates the database-update-time with the info-change-time. If the info-change-time is not more recent than the database-update-time, the agentic manager uses the app information from the database and disregards the app information from the app.

In one embodiment, when updating the database with new app information, the agentic manager may convert the data into embedding vectors and update the vector store in a RAG database to support efficient vector search operations.

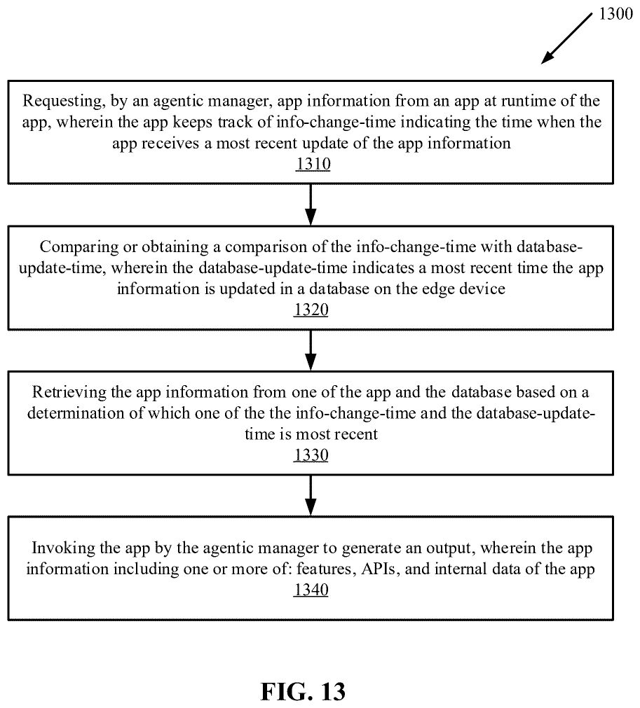

FIG. 13 is a flow diagram illustrating a method 1300 performed by an agentic manager on an edge device for runtime update of app information according to one embodiment. The agentic manager may be the agentic manager 180 in FIG. 1 or any of the aforementioned agentic managers. The agentic manager may be an agentic manager in a distributed or non-distributed agentic system. The method 1300 starts at step 1310 when the agentic manager requests app information from an app at runtime of the app. The app keeps track of info-change-time indicating the time when the app receives a most recent update of the app information. At step 1320, the agentic manager compares or obtains a comparison of the info-change-time with database-update-time. The database-update-time indicates a most recent time the app information is updated in a database on the edge device. At step 1330, the agentic manager retrieves the app information from one of the app and the database based on a determination of which one of the info-change-time and the database-update-time is most recent. At step 1340, the agentic manager invokes the app to generate an output. The app information includes one or more of: features, APIs, and internal data of the app.

FIG. 14 is a block diagram illustrating a device 1400 in an agentic system according to one embodiment. The device 1400 may be one of the nodes in a distributed agentic framework or a distributed agentic system described with reference to FIG. 1-FIG. 5. The device 1400 may alternatively be a standalone device that performs the operations of an agentic system. In some embodiments, the device 1400 may be any device that performs the aforementioned operations of an agentic manager, such as the embodiments shown in FIG. 9 and FIG. 11.

The device 1400 includes processing hardware 1410, which further includes processors 1413 and AI hardware 1412. Non-limiting examples of the processors 1413 include a central processing unit (CPU), a graphic processing unit (GPU), a digital signal processor, a media processor, etc. The processors 1413 may perform the operations of the agentic manager 180. The device 1400 further includes a memory 1420 such as a static random-access memory (SRAM) device, a dynamic random-access memory (DRAM) device, a flash memory device, and/or other volatile or non-volatile memory devices. The memory 1420 may store machine-executable instructions for the processors 1413 to perform the operations of the agentic manager 180. In some embodiments, the memory 1420 may also store agentic framework components, such as system functions 110, apps 150, databases 172 and 173, user interfaces 191, 192, and/or 193, and/or edge models 164 (FIG. 1).

The device 1400 may further include a network interface 1430, which may be a wired interface and/or a wireless interface. It is understood that the device 1400 is simplified for illustration purposes; additional hardware and software components are not shown.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method of a distributed agentic system, comprising:
receiving, by an agentic manager, a user request via one of a plurality of interaction peripherals in the distributed agentic system, wherein the distributed agentic system includes a plurality of nodes that are communicatively connected, each of the nodes is one of an edge device and a virtual machine (VM) operating on the edge device, and the plurality of interaction peripherals are coupled to a subset of the nodes to receive user requests and output responses;
sending, by the agentic manager, a prompt based on the user request to an artificial intelligence (AI) model managed by a model service;
receiving, by the agentic manager, an action plan from the AI model; and
invoking, by the agentic manager, at least one app according to the action plan to generate a response to the user request, wherein the agentic manager, the AI model, the model service, and the at least one app are located on two or more of the nodes.

2. The method of claim 1, further comprising:
initiating a plurality of user sessions in response to a plurality of user requests received via respective ones of the interaction peripherals;
prompting, by the agentic manager, AI models to obtain action plans targeting at one or more apps;
generating, by the agentic manager, action requests to apps according to the action plans; and
maintaining, by the agentic manager, a first-in-first-out (FIFO) queue for action requests that target a same app.

3. The method of claim 1, further comprising:
invoking, by the agentic manager according to the action plan, at least one service provided by one of the plurality of nodes to generate the response to the user request.

4. The method of claim 1, further comprising:
invoking, by the agentic manager according to the action plan, a Web service provided by a cloud service provider to generate the response to the user request.

5. The method of claim 1, wherein the plurality of interaction peripherals support one or more of: a graphic user interface (GUI), a voice user interface (VUI), and a sensing interface.

6. The method of claim 1, wherein the plurality of nodes communicate with each other via respective proxies over peer-to-peer communication channels.

7. The method of claim 1, wherein the plurality of nodes communicate with each other via respective proxies using a centralized name server or through a gateway.

8. The method of claim 1, further comprising:
checking, by the agentic manager, a database service that stores node identifiers identifying authorized nodes among the plurality of nodes, wherein the agentic manager is authorized to invoke apps on the authorized nodes; and
invoking, by the agentic manager, the at least one app according to the action plan to generate the response, wherein the at least one app resides on an authorized node different from a given node on which the agentic manager resides.

9. The method of claim 1, further comprising:
performing app discovery on a specific node when the user request specifies a node identifier identifying the specific node.

10. The method of claim 1, further comprising:
managing, by a session manager of the model service, a plurality of concurrent model sessions for a plurality of clients to access the AI models, wherein the clients include one or more agentic managers and apps, and wherein the managing of the plurality of concurrent model sessions further comprises:
interleaving access to a same AI model by the plurality of clients.

11. The method of claim 10, further comprising:
maintaining a session context and a request history recording pending requests for each of the concurrent model sessions; and
maintaining a global request queue for all of the concurrent model sessions, the global request queue including a plurality of entries with each entry indicating a pending request from one of the clients for one of the AI models.

12. The method of claim 1, further comprising:
sharing the model service and a database service by a plurality of agentic managers and a plurality of apps, wherein the agentic managers and the apps are located on different nodes than where the model service and the database service are located.

13. The method of claim 1, further comprising:
initiating a user session in response to the user request;
receiving, by the agentic manager, a stop request during the inference operations of the AI model;
pausing the user session; and
performing a context switch for the AI model to process the stop request, wherein the AI model is used to process both the user request and the stop request.

14. The method of claim 13, wherein the stop request is issued by another agentic manager on a second node different from a given node on which the agentic manager is located.

15. The method of claim 13, wherein the stop request is issued by one of a user and a service agent.

16. The method of claim 13, wherein subsequent to pausing the user session, the method further comprises:
performing one of remove, restart, modify, and resume operations with respect to the inference operations.

17. A distributed agent system, comprising:
a plurality of nodes that are communicatively connected, and each node is one of an edge device and a virtual machine operating on the edge device; and
a plurality of interaction peripherals coupled to a subset of the nodes to receive user requests and output responses,
wherein a given one of the nodes includes a processor and memory, the processor operative to perform operations of an agentic manager to:
receive a user request via one of the interaction peripherals;
send a prompt based on the user request to an artificial intelligence (AI) model managed by a model service;
receive an action plan from the AI model; and
invoke at least one app according to the action plan to generate a response to the user request, wherein the agentic manager, the AI model, the model service, and the at least one app are located on two or more of the nodes.

18. The system of claim 16, wherein the processor is further operative to perform the operations of the agentic manager to:
check a database service that stores node identifiers identifying authorized nodes among the plurality of nodes, wherein the agentic manager is authorized to invoke apps on the authorized nodes; and
invoke the at least one app according to the action plan to generate the response, wherein the at least one app resides on an authorized node different from the given node.

19. The system of claim 16, wherein the model service and a database service are shared by a plurality of agentic managers and a plurality of apps, wherein the agentic managers and the apps are located on different nodes than where the model service and the database service are located.

20. The system of claim 16, wherein the processor is further operative to perform the operations of the agentic manager to:
initiate a user session in response to the user request, wherein the user session is stoppable during inference operations of the AI model;
receive a stop request during the inference operations of the AI model;
pause the user session; and
perform a context switch for the AI model to process the stop request, wherein the AI model is used to process both the user request and the stop request.
